(19) United States
(12) Patent Application Publication
(10) Pub. No.: US 2024/0019162 A1
(43) Pub. Date: Jan. 18, 2024

(54) HUMIDIFIER

(71) Applicant: SHARP KABUSHIKI KAISHA, Osaka (JP)

(72) Inventors: Taisuke HOKAZONO, Osaka (JP); HIROAKI SANO, Osaka (JP); TAKAHIRO HANAI, Osaka (JP); YASUMASA SUZUKI, Osaka (JP)

(21) Appl. No.: 18/218,287

(22) Filed: Jul. 5, 2023

(30) Foreign Application Priority Data
Jul. 12, 2022 (JP) 2022-111627

(51) Int. Cl. F24F 11/89; F24F 6/04; F16K 24/04

(52) U.S. Cl. CPC F24F 11/89; F24F 6/04; F16K 24/044; F24F 2006/008

(57) ABSTRACT

A humidifier includes a water storage tank, a humidification tray, and a drive mechanism. The water storage tank includes a water refilling port, a water supply port, and a water stop valve. The water refilling port is formed to receive water refilling from outside. The water supply port is formed differently from the water refilling port. The water stop valve opens and closes the water supply port. The humidification tray is formed to receive supply of water for humidification from the water storage tank through the water supply port. The drive mechanism stops supply of water from the water storage tank to the humidification tray by driving the water stop valve in accordance with an amount of water in the humidification tray.

### CROSS-REFERENCE TO RELATED APPLICATIONS

This application claims the benefit of priority to Japanese Patent Application Number 2022-111627 filed on Jul. 12, 2022. The entire contents of the above-identified application are hereby incorporated by reference.

### BACKGROUND

### Technical Field

The disclosure relates to a humidifier equipped with a water storage tank.

A humidifier described in JP 2017-161104 A includes a water storage tank to be detachably attached to a humidification tray. A water supply port for supplying water to the humidification tray is formed in one side portion of the water storage tank. The water supply port of the water storage tank is closed by a water stop lid.

In refilling the water storage tank with water, the water stop lid is removed from the water supply port, and then the water storage tank is refilled with water through the water supply port.

### SUMMARY

The humidifier described in JP 2017-161104 A requires, in refilling the water storage tank with water, operation of removing the water storage tank from the humidification tray in advance and operation of removing the water stop lid from the water supply port. On the other hand, in a case where a water refilling port separately from the water supply port is provided in the water storage tank, the water storage tank that is being attached to the humidification tray can be refilled with water.

However, an internal pressure of the water storage tank does not increase at the time of water refilling from the water refilling port, and thus, water supply from the water storage tank to the humidification tray is not automatically stopped even when a level of water with which the humidification tray is refilled reaches a position corresponding to full water level. As a result, water may overflow from the humidification tray at the time of water refilling.

The disclosure has been made in view of the above-described problem, and an object thereof is to provide a humidifier capable of improving workability of refilling a water storage tank with water while avoiding overflow of water from a humidification tray.

A humidifier according to the disclosure includes a water storage tank, a humidification tray, and a drive mechanism. The water storage tank includes a water refilling port, a water supply port, and a water stop valve. The water refilling port receives water refilling from outside. The water supply port is formed differently from the water refilling port. The water stop valve opens and closes the water supply port. The humidification tray receives supply of water for humidification from the water storage tank through the water supply port. The drive mechanism stops supply of water from the water storage tank to the humidification tray by driving the water stop valve in accordance with an amount of water in the humidification tray.

The humidifier of the disclosure can improve workability of refilling the water storage tank with water while avoiding overflow of water from the humidification tray.

### BRIEF DESCRIPTION OF DRAWINGS

The disclosure will be described with reference to the accompanying drawings, wherein like numbers reference like elements.

FIG. 1 is a perspective view of a humidifier according to a first embodiment of the disclosure.

FIG. 2 is a perspective view of a water storage tank according to the first embodiment.

FIG. 3 is an explanatory diagram of a drive mechanism according to the first embodiment at an initial stage of water refilling.

FIG. 4 is an explanatory diagram of the drive mechanism according to the first embodiment at a later stage of water refilling.

FIG. 5 is a graph showing a correlation between a force applied to a water receiving portion and a mass of water.

FIG. 6 is an explanatory diagram of a drive mechanism according to a second embodiment of the disclosure at an initial stage of water refilling.

FIG. 7 is an explanatory diagram of the drive mechanism according to the second embodiment at a later stage of water refilling.

FIG. 8 is an explanatory diagram of a drive mechanism according to a third embodiment of the disclosure at an initial stage of water refilling.

FIG. 9 is an explanatory diagram of the drive mechanism according to the third embodiment at a later stage of water refilling.

FIG. 10 is an explanatory diagram of a drive mechanism according to a fourth embodiment of the disclosure at an initial stage of water refilling.

FIG. 11 is an explanatory diagram of the drive mechanism according to the fourth embodiment at a later stage of water refilling.

FIG. 12 is an explanatory diagram of a drive mechanism according to a modified example of the disclosure at an initial stage of water refilling.

FIG. 13 is an explanatory diagram of the drive mechanism according to the modified example at a later stage of water refilling.

### DESCRIPTION OF EMBODIMENTS

Embodiments of the disclosure will be described hereinafter with reference to the accompanying drawings. In the drawings, the same or equivalent components are denoted by the same reference numerals and signs, and description thereof is not repeated.

### First Embodiment

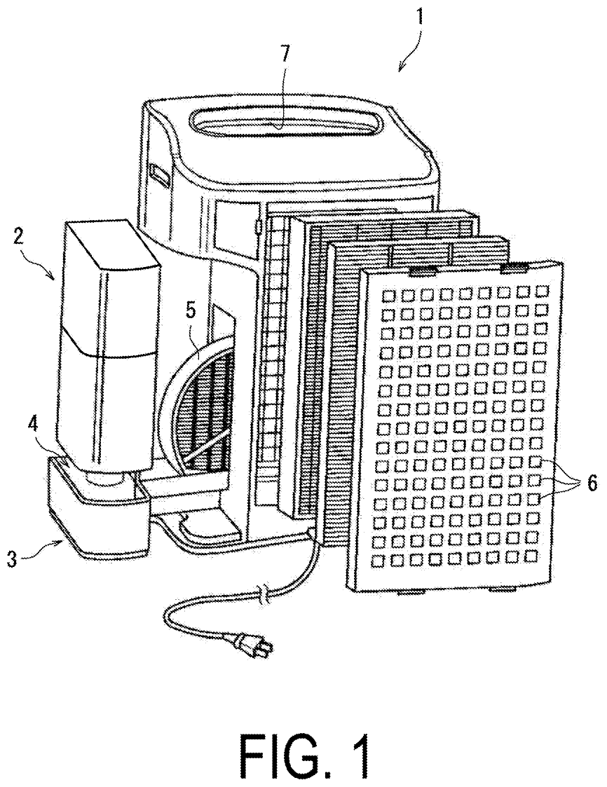

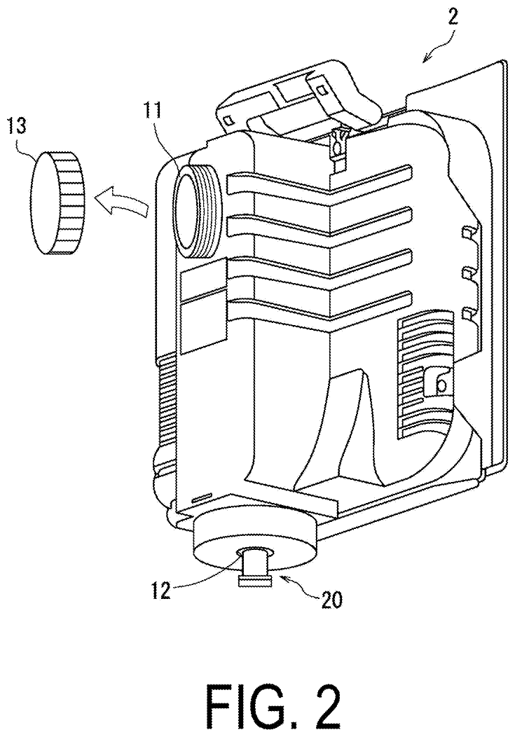

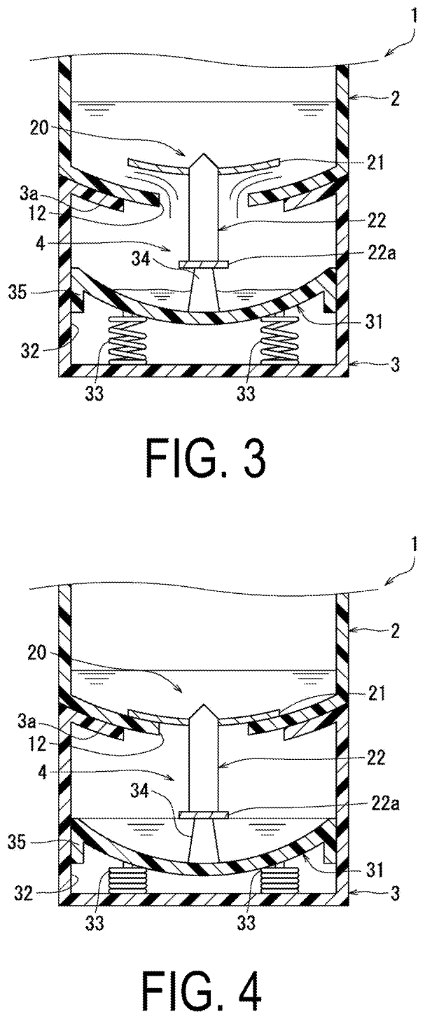

A humidifier 1 according to a first embodiment of the disclosure will be described with reference to FIG. 1 to FIG. 5. FIG. 1 is a perspective view of the humidifier 1. FIG. 2 is a perspective view of a water storage tank 2. FIG. 3 is an explanatory diagram of a drive mechanism 4 at an initial stage of water refilling.

As illustrated in FIG. 1, the humidifier 1 includes the water storage tank 2, a humidification tray 3, and the drive mechanism 4 inside a housing having a rectangular box shape.

The humidifier 1 is, for example, a vaporizing humidifier. The humidifier 1 further includes a humidification filter 5, an air intake port 6, and an air blow port 7. The humidification filter 5 can be impregnated with water. Specifically, the humidification filter 5 is disposed in a middle portion of an air sending path (not illustrated) connecting the air intake port 6 and the air blow port 7 of the humidifier 1. Air is introduced into the air sending path and is passed to an air sending fan (not illustrated) through the humidification filter 5. Moist air is finally sent outside from the air blow port 7. The air to be introduced into the air sending path may be passed to the humidification filter 5 through the air sending fan.

As illustrated in FIG. 2, the water storage tank 2 is a hollow container made of a synthetic resin and having a substantially rectangular tubular shape. The water storage tank 2 has a capacity larger than a storage capacity of the humidification tray 3. Water in the water storage tank 2 is supplied to the humidification filter 5 through the humidification tray 3. The water storage tank 2 includes a water refilling port 11, a water supply port 12 different from the water refilling port 11, and a water stop valve 20. The water stop valve 20 opens and closes the water supply port 12. A user can refill the water storage tank 2 that is being attached to the humidification tray 3 with water.

The water refilling port 11 receives water refilling from outside (for example, a water tap). The water refilling port 11 is formed in the other side portion (upper half portion) of the water storage tank 2. The water refilling port 11 is opened toward a lateral side of the tank 2 in a tank attached state. A screw thread is uniformly provided in an outer periphery portion of the water refilling port 11. The water refilling port 11 is openably closed by a screw-in water refilling lid 13. The “tank attached state” means a state in which the water storage tank 2 is normally attached to the humidification tray 3. In the embodiment, an example of the water refilling port 11 provided lateral to the tank 2 is described, but the water refilling port 11 may be formed in the upper portion of the tank 2.

Water is supplied from the water storage tank 2 to the humidification tray 3 through the water supply port 12. The water supply port 12 is formed in one end portion (lower end portion) of the water storage tank 2. The water supply port 12 is opened downward in the tank attached state. The water supply port 12 is opened and closed by the water stop valve 20.

As illustrated in FIG. 3, the water storage tank 2 is disposed on the humidification tray 3. The humidification tray 3 includes, at its upper end portion, a protruding portion 3a that protrudes toward the inside of the tray. A lower end portion of the water storage tank 2 is placed on the protruding portion 3a. Specifically, the water storage tank 2 is a cartridge-type tank that is attachable to and detachable from the humidification tray 3.

Next, the water stop valve 20 and the drive mechanism 4 will be described with reference to FIG. 3 to FIG. 5.

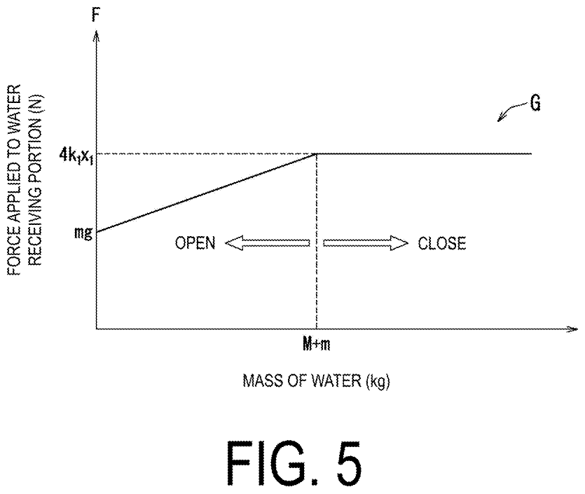

FIG. 4 is an explanatory diagram of the drive mechanism 4 at a later stage of water refilling. FIG. 5 is a graph G showing a correlation between a force applied to a water receiving portion 31 and a mass of water. Hereinafter, description will be given on the premise of the tank attached state. For convenience of description, supply of water to the water storage tank 2 through the water refilling port 11 is referred to as water refilling. Supply of water to the humidification tray 3 through the water supply port 12 is referred to as water supply.

As illustrated in FIG. 3, the water stop valve 20 includes a valve body 21 and a rod body 22.

The valve body 21 has a substantial disc shape having a diameter larger than that of the water supply port 12. The valve body 21 is disposed inside the water storage tank 2. As a result, the valve body 21 closes the water supply port 12 from the inside of the water storage tank 2.

The rod body 22 is disposed along a vertical line at a center position of the water supply port 12. The rod body 22 moves forward and backward in and out of the water supply port 12. The valve body 21 is disposed at an upper end portion of the rod body 22. The rod body 22 includes a seating portion 22a. The seating portion 22a is disposed at a lower end portion of the rod body 22.

The drive mechanism 4 includes the water receiving portion 31, a guide portion 32, and a plurality of biasing members 33. In the embodiment, the number of the biasing members 33 is four. The water receiving portion 31 moves downward in accordance with a weight of water in the water receiving portion 31. The water stop valve 20 is closed by the downward movement of the water receiving portion 31. As a result, the drive mechanism 4 drives the water stop valve 20 in accordance with a mass of water stored in the water receiving portion 31.

The water receiving portion 31 has a substantially rectangular shape in a plan view. The water receiving portion 31 stores water supplied from the water storage tank 2 to the humidification tray 3. The guide portion 32 guides up-down movement of the water receiving portion 31. The biasing members 33 are disposed at respective positions near four corners of the water receiving portion 31 in a plan view. Each of the biasing members 33 biases the water receiving portion 31 upward.

As illustrated in FIG. 3, the water receiving portion 31 is formed in a substantially spherical shape curved downward. The water receiving portion 31 includes a base portion 34 and a slide portion 35. The base portion 34 is disposed at a central portion of the water receiving portion 31. The base portion 34 protrudes upward. An upper end portion of the base portion 34 abuts onto the seating portion 22a from below to support the water stop valve 20 in the tank attached state. The water receiving portion 31 is not limited to what is formed in a substantially spherical shape curved downward. It is only required that the water receiving portion 31 can at least store water. For example, the water receiving portion 31 may have a rectangular parallelepiped shape.

The slide portion 35 is provided at an outer edge portion of four sides of the water receiving portion 31. The slide portion 35 is bent downward from the outer edge portion of four sides. When the water receiving portion 31 moves up and down, the slide portion 35 is guided by the guide portion 32. When the water receiving portion 31 moves up and down, the slide portion 35 slides on the guide portion 32. The guide portion 32 corresponds to an inner wall surface of the humidification tray 3.

The four biasing members 33 are disposed corresponding to the respective four corners of the water receiving portion 31.

When a predetermined amount of water is not stored in the humidification tray 3, the valve body 21 opens the water supply port 12. A spring constant of each of the biasing members 33 is k₁, a contraction amount of each of the biasing members 33 is x₁, a mass of the water receiving portion 31 is m, the gravitational acceleration is g, and the following relationship is established.

m×g<4×k₁×x₁ (1)

The valve body 21 closes the water supply port 12 when a water level of the water receiving portion 31 reaches a position corresponding to full water level. A mass of water at the time of the full water level is M, and the following relationship is established.

4×k₁×x₁<m×g+M×g (2)

The graph G shown in FIG. 5 is created based on the relationships (1) and (2).

The graph G shows a correlation between the mass of water and the force applied to the water receiving portion 31. Conditions of the spring constant k₁ of each of the biasing members 33 and the mass m of the water receiving portion 31 are set such that the correlation of the graph G is established.

Next, operation of the drive mechanism 4 at the time of water refilling will be described with reference to FIG. 3 and FIG. 4. As illustrated in FIG. 3, when no water is stored in the humidification tray 3 (including a case where a small amount of water is stored) and the tank in being attached, each of the biasing members 33 extends. As a result, the seating portion 22a of the rod body 22 abuts onto the base portion 34. This pushes up the water stop valve 20 to open the water supply port 12. As a result, water is discharged from the water supply port 12 and is continuously supplied to the humidification tray 3.

As illustrated in FIG. 4, when water stored in the humidification tray 3 reaches the position corresponding to the full water level, each of the biasing members 33 contracts downward. As a result, the rod body 22 lowers. Accordingly, the valve body 21 lowered closes the water supply port 12. Thus, even refilling the water storage tank 2 that is being attached to the humidification tray 3 with water avoids overflow of water from the humidification tray 3.

According to the first embodiment as described above with reference to FIG. 1 to FIG. 5, the water storage tank 2 includes the water refilling port 11, the water supply port 12 different from the water refilling port 11, and the water stop valve 20 that opens and closes the water supply port 12. As a result, the drive mechanism 4 can operate the water stop valve 20 in accordance with the mass of water stored in the water receiving portion 31. This allows the user to refill the water storage tank 2 that is being attached to the humidification tray 3 with water. The drive mechanism 4 stops supply of water from the water storage tank 2 to the humidification tray 3 by driving the water stop valve 20 in accordance with the amount of water in the humidification tray 3. As a result, overflow of water from the humidification tray 3 can be avoided. This can improve the workability of refilling the water storage tank 2 with water while avoiding overflow of water from the humidification tray 3.

In addition, according to the first embodiment, the drive mechanism 4 includes the water receiving portion 31 configured to store water supplied from the water storage tank 2 to the humidification tray 3, the guide portion 32 configured to guide the up-down movement of the water receiving portion 31, and the biasing members 33 configured to bias the water receiving portion 31 upward. As a result, a height position of the water receiving portion 31 can be changed in accordance with the mass of water. The drive mechanism 4 closes the water stop valve 20 in accordance with the mass of water stored in the water receiving portion 31. As a result, change of a structure of the water stop valve 20 can be eliminated. This can simplify the configuration of the drive mechanism 4.

Furthermore, according to the first embodiment, the water receiving portion 31 includes the base portion 34 configured to support the water stop valve 20. As a result, displacement of the height position of the water receiving portion 31 can be directly reflected in displacement of the height position of the water stop valve 20.

### Second Embodiment

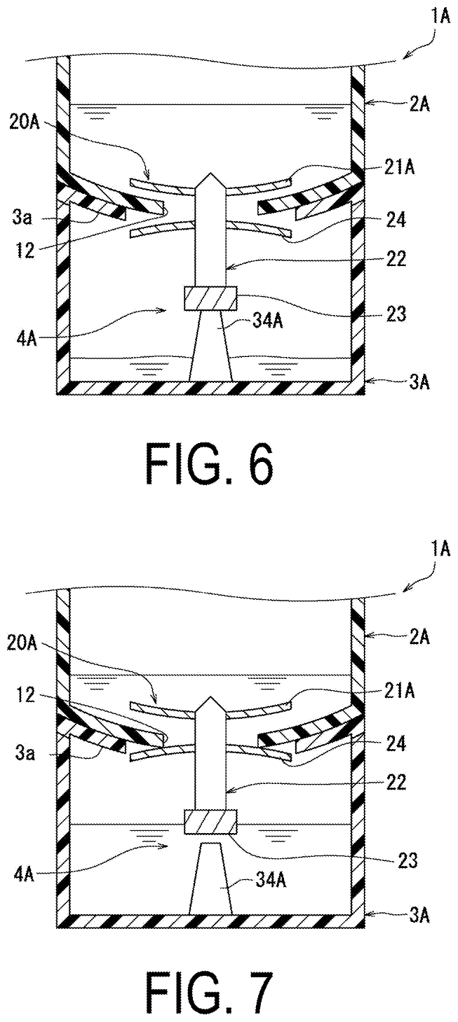

Next, a humidifier 1A according to a second embodiment of the disclosure will be described with reference to FIG. 6 and FIG. 7. In the first embodiment, the drive mechanism 4 operates in accordance with the mass of water stored in the water receiving portion 31. In the second embodiment, a drive mechanism 4A operates in accordance with a level of water stored in a humidification tray 3A. Hereinafter, differences between the first embodiment and the second embodiment will be described. FIG. 6 is an explanatory diagram of the drive mechanism 4A at an initial stage of water refilling. FIG. 7 is an explanatory diagram of the drive mechanism 4A at a later stage of water refilling.

As illustrated in FIG. 6, the drive mechanism 4A includes a humidification tray 3A and a water stop valve 20A. The humidification tray 3A includes a base portion 34A.

The base portion 34A protrudes upward from a bottom face of the humidification tray 3A. The base portion 34A is disposed below the water supply port 12 and supports the water stop valve 20A. As a result, the base portion 34A pushes up the water stop valve 20A.

The water stop valve 20A includes a first valve body 21A, a rod body 22, a floating member 23, and a second valve body 24. The first valve body 21A and the second valve body 24 are each fixed to the rod body 22. The first valve body 21A and the second valve body 24 are spaced apart from each other in the longitudinal direction of the rod body 22. The floating member 23 is fixed to a lower end portion of the rod body 22. The first valve body 21A is disposed inside a water storage tank 2A. The second valve body 24 is disposed outside the water storage tank 2A.

The floating member 23 can generate a buoyant force larger than a mass of the water stop valve 20A. The floating member 23 moves up and down in accordance with the water level in the humidification tray 3A. The first valve body 21A then closes the water supply port 12 from the inside of the water storage tank 2A. The second valve body 24 closes the water supply port 12 from the outside of the water storage tank 2A.

The water stop valve 20A moves upward in synchronization with the rise of the water level in the humidification tray 3A. When the floating member 23 abuts onto the base portion 34A, the first valve body 21A moves upward to separate from the water supply port 12. When water stored in the humidification tray 3A reaches a position corresponding to a full water level, the second valve body 24 abuts onto a bottom portion of the water storage tank 2A. Specifically, the second valve body 24 closes the water supply port 12.

Next, operation of the drive mechanism 4A at the time of water refilling will be described with reference to FIG. 6 and FIG. 7. As illustrated in FIG. 6, when no water is stored in the humidification tray 3A and the tank is being attached at an initial stage of water refilling, the floating member 23 abuts onto a top of the base portion 34A. The first valve body 21A and the second valve body 24 open the water supply port 12. As a result, water is supplied to the humidification tray 3A side through the water supply port 12.

As illustrated in FIG. 7, when water stored in the humidification tray 3A reaches a position corresponding to the full water level at the later stage of water refilling, the second valve body 24 moves upward to close the water supply port 12. As a result, even refilling the water storage tank 2A that is being attached to the humidification tray 3A with water avoids overflow of water from the humidification tray 3A.

According to the second embodiment as described above with reference to FIG. 6 and FIG. 7, the water stop valve 20A opens and closes the water supply port 12 in conjunction with the up-down movement of the floating member 23. As a result, change a structure of the humidification tray 3A is eliminated. This can simplify the configuration of the drive mechanism 4A.

The first valve body 21A opens the water supply port 12 when the rod body 22 is pushed up by the base portion 34A. The second valve body 24 closes the water supply port 12 when the floating member 23 floats upward. The floating member 23 floats upward in accordance with an amount of water in the humidification tray 3A.

The first valve body 21A closes the water supply port 12 from the inside of the water storage tank 2A, and the second valve body 24 closes the water supply port 12 from the outside of the water storage tank 2A. As a result, the structure of the water stop valve 20A can be simplified.

### Third Embodiment

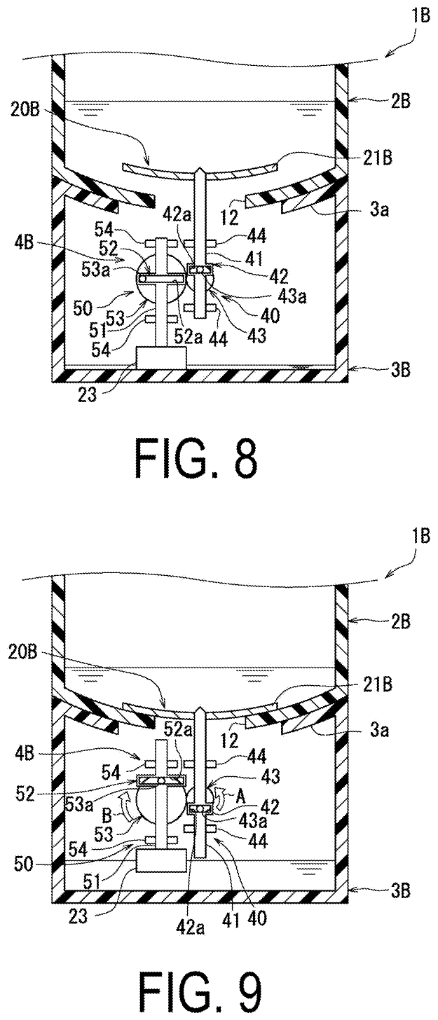

Next, a humidifier 1B according to a third embodiment of the disclosure will be described with reference to FIG. 8 and FIG. 9. In the second embodiment, the floating member 23 directly transmits the change in water level to the first valve body 21A and the second valve body 24 via the single rod body 22. In the third embodiment, an up-down linear motion of the floating member 23 due to the water level is converted into a rotational motion and is then converted into an up-down linear motion of a valve body 21B. Hereinafter, differences between the second embodiment and the third embodiment will be described. FIG. 8 is an explanatory diagram of a drive mechanism 4B at an initial stage of water refilling. FIG. 9 is an explanatory diagram of the drive mechanism 4B at a later stage of water refilling.

As illustrated in FIG. 8, the drive mechanism 4B includes two scotch yoke mechanisms 40 and 50 coupled to each other. Hereinafter, the scotch yoke mechanism 40 may be referred to as a first scotch yoke mechanism 40, and the scotch yoke mechanism 50 may be referred to as a second scotch yoke mechanism 50. In addition, the drive mechanism 4B includes a humidification tray 3B and a water stop valve 20B. The humidification tray 3B omits the base portion. The base portion typically protrudes upward from a bottom face of the humidification tray 3B. However, in the third embodiment, the base portion is omitted.

The water stop valve 20B includes the first scotch yoke mechanism 40, the second scotch yoke mechanism 50, a valve body 21B, and a floating member 23. The water stop valve 20B interlocks with operation of the first scotch yoke mechanism 40 and the second scotch yoke mechanism 50. As a result, the water stop valve 20B opens and closes the water supply port 12.

As illustrated in FIG. 8, the first scotch yoke mechanism 40 includes a first rod member 41, a first yoke member 42, a first gear member 43, and a plurality of guide members 44. Specifically, two sets of the guide members 44 are provided.

The first rod member 41 extends in an up-down direction. The first yoke member 42 is disposed at a middle portion of the first rod member 41. The valve body 21B is disposed at an upper end portion of the first rod member 41. The valve body 21B opens and closes the water supply port 12. The first yoke member 42 includes a guide opening portion 42a. The guide opening portion 42a has a rectangular shape extending in a horizontal direction.

A rotation axis of the first gear member 43 is substantially orthogonal to the first rod member 41 and the first yoke member 42. The first gear member 43 includes a first pin 43a parallel to the rotation axis of the first gear member 43. The first pin 43a is inserted into the guide opening portion 42a of the first yoke member 42. The first pin 43a is slidably guided by the first yoke member 42 in a horizontal direction.

The first rod member 41 includes two sets of upper and lower guide members 44. The respective two sets of guide members 44 are disposed at an upper position of the first yoke member 42 and at a lower position of the first yoke member 42. The two sets of guide members 44 guide the first rod member 41 to be movable up and down in the up-down direction. When the first pin 43a rotationally moves to the highest height position, the valve body 21B opens most. When the first pin 43a rotationally moves to the lowest height position, the valve body 21B closes.

As illustrated in FIG. 8, the second scotch yoke mechanism 50 includes a second rod member 51, a second yoke member 52, a second gear member 53, and a plurality of guide members 54. Specifically, two sets of guide members 54 are provided.

The second rod member 51 extends in the up-down direction. The second yoke member 52 is disposed at a middle portion of the second rod member 51. The floating member 23 is disposed at a lower end portion of the second rod member 51. The floating member 23 floats the second scotch yoke mechanism 50. The second yoke member 52 includes a guide opening portion 52a. The guide opening portion 52a has a rectangular shape extending in a horizontal direction.

The rotation axis of the second gear member 53 is substantially orthogonal to the second rod member 51 and the second yoke member 52. The number of teeth of the second gear member 53 is twice the number of teeth of the first gear member 43 that meshes with the second gear member 53. The second gear member 53 includes a second pin 53a parallel to the rotation axis of the second gear member 53. The second pin 53a is inserted into the guide opening portion 52a of the second yoke member 52. The second pin 53a is slidably guided by the second yoke member 52 in a horizontal direction.

The second rod member 51 includes two sets of upper and lower guide members 54. The respective two sets of guide members 54 are disposed at an upper position of the second yoke member 52 and at a lower position of the second yoke member 52. The two sets of guide members 54 guide the second rod member 51 to be movable up and down in the up-down direction.

When water stored in the humidification tray 3B reaches a position corresponding to the full water level, the second pin 53a is rotationally moved to the highest height position by a buoyant force of the floating member 23. The buoyant force of the floating member 23 is larger than a driving force for rotationally moving the second pin 53a. When the second pin 53a rotationally moves to the highest height position or the lowest height position, the first pin 43a rotationally moves to the lowest height position. When the second pin 53a rotationally moves to an intermediate position, the first pin 43a rotationally moves to the highest height position.

Next, operation of the drive mechanism 4B at the time of water refilling will be described with reference to FIG. 8 and FIG. 9. Before the water storage tank 2B is attached to the humidification tray 3B, the second pin 53a rotationally moves to the lowest height position due to a weight of the second rod member 51. The valve body 21B closes. When the water storage tank 2B is attached to the humidification tray 3B, a bottom portion of the humidification tray 3B pushes the floating member 23 upward. With the rise of the floating member 23, the second pin 53a is rotated clockwise to move to the intermediate position.

As illustrated in FIG. 8, when no water is stored in the humidification tray 3B and the tank is being attached at an initial stage of water refilling, the floating member 23 is at the bottom portion of the humidification tray 3B or near the bottom portion. The second pin 53a moves to the intermediate position, and thus the valve body 21B opens.

As illustrated in FIG. 9, when water stored in the humidification tray 3B reaches the position corresponding to the full water level at a later stage of water refilling, the floating member 23 rises. With the rise of the floating member 23, the second pin 53a rotates from the intermediate position to the highest height position, for example, by a predetermined angle in a clockwise direction B. Specifically, the predetermined angle corresponds to a quarter turn. In synchronization with the rotation of the second gear member 53, the first gear member 43 rotates, for example, by a predetermined angle in a counterclockwise direction A. Specifically, the predetermined angle corresponds to a half turn. As a result, the first pin 43a moves from the highest height position to the lowest height position. Although an example in which the first gear member 43 rotates by a predetermined angle in the counterclockwise direction A and the second gear member 53 rotates by a predetermined angle in the clockwise direction B is described, the first gear member 43 may rotate by a predetermined angle in the clockwise direction B, and the second gear member 53 may rotate by a predetermined angle in the counterclockwise direction A.

According to the third embodiment as described above with reference to FIG. 8 and FIG. 9, the water stop valve 20B opens and closes the water supply port 12 in conjunction with the operations of the first scotch yoke mechanism 40 and the second scotch yoke mechanism 50. As a result, the base portion can be omitted from the humidification tray 3B. The drive mechanism 4B can convert a linear motion of the floating member 23 into a rotational motion. The drive mechanism 4B can further convert the rotational motion into a linear motion and transmit the linear motion to the valve body 21B.

### Fourth Embodiment

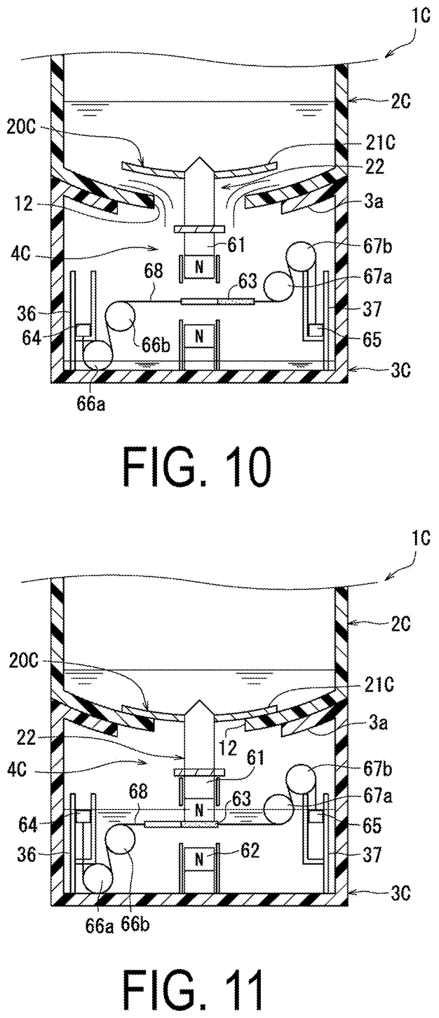

Next, a humidifier 1C according to a fourth embodiment of the disclosure will be described with reference to FIG. 10 and FIG. 11. In the second embodiment, the first and second valve bodies 21A and 24 are driven using a change in water level. The fourth embodiment uses a magnetic force of permanent magnets 61 and 62 to drive a valve body 21C. Hereinafter, differences between the second embodiment and the fourth embodiment will be described. FIG. 10 is an explanatory diagram of a drive mechanism 4C at an initial stage of water refilling. FIG. 11 is an explanatory diagram of the drive mechanism 4C at a later stage of water refilling.

As illustrated in FIG. 10, the drive mechanism 4C includes a humidification tray 3C and a water stop valve 20C. The water stop valve 20C includes a valve body 21C, a rod body 22, and a first permanent magnet 61. The valve body 21C is fixed to the rod body 22. The first permanent magnet 61 is fixed to a lower end portion of the rod body 22 such that one polarity (for example, the north pole) is positioned below.

The humidification tray 3C includes a second permanent magnet 62, a slide member 63, floating members 64 and 65, and pulleys 66a, 66b, 67a, and 67b. The second permanent magnet 62 is disposed below the first permanent magnet 61 with a predetermined gap therebetween. The second permanent magnet 62 is fixed to the humidification tray 3C such that one polarity (for example, the north pole) is positioned above. In other words, the first permanent magnet 61 and the second permanent magnet 62 are disposed to have opposite polarities.

The slide member 63 inserts and removes a magnetic body portion between the first permanent magnet 61 and the second permanent magnet 62 in conjunction with a movement of the floating members 64 and 65 in an up-down direction. The slide member 63 controls operation of the water stop valve 20C by inserting and removing the magnetic body portion. The operation of the water stop valve 20C controls opening and closing of the water supply port 12.

Specifically, the slide member 63 includes a non-magnetic body portion on one side (for example, the left side in the drawing) in a longitudinal direction of the slide member 63 and a magnetic body portion that is a magnetic metal on the other side (for example, the right side in the drawing) in the longitudinal direction of the slide member 63. The slide member 63 is disposed between the first permanent magnet 61 and the second permanent magnet 62 and moves in a horizontal direction. The slide member 63 may use a magnet having one polarity on one side and the other polarity on the other side.

The floating members 64 and 65 are disposed on the humidification tray 3C with the water stop valve 20C interposed therebetween. The floating members 64 and 65 are coupled via a coupling member 68. The slide member 63 is disposed at an intermediate portion of the coupling member 68.

The floating member 64 is accommodated in an elevation guide portion 36. The pulleys 66a and 66b are disposed in the vicinity of a lower end of the elevation guide portion 36. One side end portion of the coupling member 68 is coupled to a lower end portion of the floating member 64 via the pulleys 66a and 66b.

The floating member 65 is accommodated in an elevation guide portion 37. The pulleys 67a and 67b are disposed in the vicinity of an upper end of the elevation guide portion 37. The other side end portion of the coupling member 68 is coupled to an upper end portion of the floating member 64 via the pulleys 67a and 67b.

The floating members 64 and 65 move up and down in accordance with a level of water stored in the humidification tray 3C. The floating members 64 and 65 are driven to substantially the same height position by the pulleys 66a, 66b, 67a, and 67b. When the floating members 64 and 65 are at the lowest height position, the non-magnetic body portion of the slide member 63 is interposed between the first permanent magnet 61 and the second permanent magnet 62. When the floating members 64 and 65 are at a position corresponding to the full water level, the magnetic body portion of the slide member 63 is interposed between the first permanent magnet 61 and the second permanent magnet 62. The water stop valve 20C closes the water supply port 12 when the first permanent magnet 61 and the second permanent magnet 62 come closest to each other.

Next, operation of the drive mechanism 4C at the time of water refilling will be described with reference to FIG. 10 and FIG. 11. As illustrated in FIG. 10, when no water is stored in the humidification tray 3C and the tank is being attached at an initial stage of water refilling, the non-magnetic body portion of the slide member 63 is interposed between the first permanent magnet 61 and the second permanent magnet 62. As a result, a repulsive force acts between the first permanent magnet 61 and the second permanent magnet 62 to increase a separation distance therebetween. Thus, water is supplied to the humidification tray 3C through the water supply port 12.

As illustrated in FIG. 11, when water stored in the humidification tray 3C reaches a position corresponding to the full water level at a later stage of water refilling, the magnetic body portion of the slide member 63 is interposed between the first permanent magnet 61 and the second permanent magnet 62. As a result, an attractive force acts between the first permanent magnet 61 and the second permanent magnet 62 to reduce the separation distance therebetween. Thus, water supply to the humidification tray 3C is stopped.

As described above with reference to FIG. 10 and FIG. 11, according to the fourth embodiment, the drive mechanism 4C includes the first permanent magnet 61, the second permanent magnet 62, and the slide member 63. As a result, the drive mechanism 4C inserts and removes the slide member 63 between the first permanent magnet 61 and the second permanent magnet 62 in conjunction with the up-down movement of the floating members 64 and 65. The horizontal movement of the slide member 63 causes the water stop valve 20C to control opening and closing of the water supply port 12.

The embodiments of the disclosure have been described above with reference to the drawings. However, the disclosure is not limited to the embodiment described above, and the disclosure can be implemented in various modes without departing from the gist thereof. Further, the disclosure can be made in various forms by appropriately combining a plurality of components disclosed in the embodiments described above. For example, some components may be removed from all of the components described in the embodiments. Furthermore, the components across different embodiments may be appropriately combined. For easier understanding, the drawings schematically illustrate the respective main components, and the thickness, length, number, interval, or the like of illustrated components may differ from actuality for the sake of convenience in creating the drawings. The material, shape, dimensions, and the like of each of the components illustrated in the embodiments described above are merely exemplary and are not particularly limited, and various modifications can be made within the scope not departing from the effects of the disclosure in essence.

In the embodiments as described with reference to FIG. 1 to FIG. 11, the amounts of water in the humidification trays 3 to 3C drive the water stop valves 20 to 20C, respectively. However, the disclosure is not limited to the embodiments.

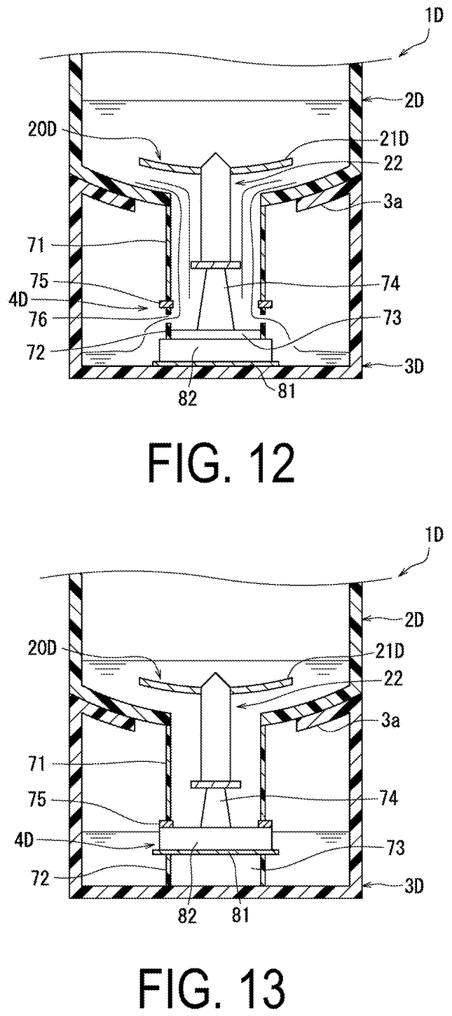

A humidifier 1D according to a modified example of the disclosure will be described with reference to FIG. 12 and FIG. 13. FIG. 12 is an explanatory diagram of a drive mechanism 4D at an initial stage of water refilling. FIG. 13 is an explanatory diagram of the drive mechanism 4D at a later stage of water refilling. In the modified example, an amount of water in a humidification tray 3D controls opening and closing of a discharge hole 76 for water supply.

As illustrated in FIG. 12, the drive mechanism 4D includes a water storage tank 2D and a humidification tray 3D. The water storage tank 2D includes a water stop valve 20D and a first coupling portion 71.

The first coupling portion 71 has a cylindrical shape extending downward. A valve body 21D of the water stop valve 20D is accommodated in the water storage tank 2D. The valve body 21D closes an upstream end portion of the first coupling portion 71. A rod body 22 moves up and down in an up-down direction in the first coupling portion 71.

The humidification tray 3D includes a second coupling portion 72, a foundation portion 73, and a base portion 74. The second coupling portion 72 has a cylindrical shape extending upward from a bottom portion of the humidification tray 3D. A seal portion 75 having an annular shape is disposed at an upper end portion of the second coupling portion 72. The discharge hole 76 through which supplied water can be discharged is disposed in a middle portion of the second coupling portion 72.

When the water storage tank 2D is attached to the humidification tray 3D, the seal portion 75 seals a gap between a lower end portion of the first coupling portion 71 and the upper end portion of the second coupling portion 72. As a result, water stored in the water storage tank 2D flows through the first coupling portion 71 and the second coupling portion 72. Water having flowed through the first coupling portion 71 and the second coupling portion 72 is supplied to the humidification tray 3D from the discharge hole 76.

The foundation portion 73 is formed in a columnar shape. A floating member 81 and a cover member 82 are disposed around the foundation portion 73. The floating member 81 is formed in an annular shape. The cover member 82 is disposed on the floating member 81. As a result, the cover member 82 and the floating member 81 integrally float upward in supplying water.

The base portion 74 is disposed on the upper portion of the foundation portion 73. When the water storage tank 2D is attached to the humidification tray 3D, the top portion of the base portion 74 abuts onto the water stop valve 20D from below. The floating member 81 rises with the rise of the water level. When the floating member 81 reaches a position corresponding to the full water level, the cover member 82 closes the discharge hole 76.

Next, operation of the drive mechanism 4D at the time of water refilling will be described with reference to FIG. 12 and FIG. 13. As illustrated in FIG. 12, when no water is stored in the humidification tray 3D and the tank is being attached at an initial stage of water refilling, the water stop valve 20D opens. Water is supplied to the humidification tray 3D through the discharge hole 76. The cover member 82 rises in synchronization with the rise of the floating member 81.

As illustrated in FIG. 13, when water stored in the humidification tray 3D reaches the position corresponding to the full water level at a later stage of water refilling, the cover member 82 closes the discharge hole 76 in synchronization with the rise of the floating member 81. As a result, water supply to the humidification tray 3D is stopped.

In the first embodiment described with reference to FIG. 3 to FIG. 5, an example in which the relationships (1) and (2) are established in a case where four biasing members 33 are disposed has been described. However, the number of the biasing members 33 is not limited to four, and any number can be set. For example, in a case where the number of the biasing members 33 of the water receiving portion 31 is N (≥1) other than 4, at least the following relationship is established.

M×g<N×k₁×x₁ (3)

### INDUSTRIAL APPLICABILITY

The disclosure provides a humidifier, and the provided humidifier has industrial applicability.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A humidifier, comprising:
a water storage tank including a water refilling port configured to receive water refilling from outside, a water supply port different from the water refilling port, and a water stop valve configured to open and close the water supply port;
a humidification tray configured to receive supply of water for humidification from the water storage tank through the water supply port; and
a drive mechanism configured to stop supply of water from the water storage tank to the humidification tray by driving the water stop valve in accordance with an amount of water in the humidification tray.

2. The humidifier according to claim 1,
wherein the drive mechanism includes
a water receiving portion configured to store water supplied from the water storage tank to the humidification tray,
a guide portion configured to guide up-down movement of the water receiving portion, and
a biasing member configured to bias the water receiving portion upward, and
the water receiving portion moves downward in accordance with a weight of water in the water receiving portion, thus closing the water stop valve.

3. The humidifier according to claim 2,
wherein the water receiving portion includes a base portion configured to support the water stop valve.

4. The humidifier according to claim 1,
wherein the drive mechanism includes a floating member configured to move up and down in accordance with a water level in the humidification tray, and
the water stop valve opens and closes the water supply port in conjunction with up-down movement of the floating member.

5. The humidifier according to claim 4,
wherein the water stop valve includes
a rod body, and
a first valve body and a second valve body spaced apart from each other in a longitudinal direction of the rod body and fixed to the rod body,
the floating member is further fixed to the rod body,
the humidification tray includes a base portion configured to support the water stop valve,
the first valve body opens the water supply port when the rod body is pushed up by the base portion, and
the second valve body closes the water supply port when the floating member floats upward in accordance with a water level in the humidification tray.

6. The humidifier according to claim 5,
wherein the first valve body closes the water supply port from inside of the water storage tank, and the second valve body closes the water supply port from outside of the water storage tank.

7. The humidifier according to claim 4,
wherein the drive mechanism includes two scotch yoke mechanisms coupled to each other, and
the water stop valve opens and closes the water supply port in conjunction with operation of the two scotch yoke mechanisms.

8. The humidifier according to claim 4,
wherein the water stop valve includes
a rod body, and
a valve body fixed to the rod body, and
the drive mechanism includes
a first permanent magnet fixed to the rod body,
a second permanent magnet fixed to the humidification tray and having a polarity opposite to a polarity of the first permanent magnet, and
a slide member configured to control the water supply port to open and close the water stop valve by inserting and removing a magnetic body between the first permanent magnet and the second permanent magnet in conjunction with the up-down movement of the floating member.
